(19) United States
(12) Patent Application Publication
(10) Pub. No.: US 2007/0282609 A1
(43) Pub. Date: Dec. 6, 2007

(54) Electronic device and control program

(75) Inventors: Yuji Okada, Sapporo (JP); Rikiya Maeda, Sapporo (JP); Tsutomu Hoshi, Sapporo (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/826,351

(22) Filed: Jul. 13, 2007

Related U.S. Application Data
(63) Continuation of application No. PCT/JP05/00280, filed on Jan. 13, 2005.

(51) Int. Cl. G10L 13/08

(52) U.S. Cl. 704/260

(57) ABSTRACT

The present invention provides an electronic device capable of offering a user easy-to-understand guidance on button operations, and a control program that controls the electronic device. The electronic device has a memory (110) that stores an audible text explaining a button operation, a guidance speaker control section (135) that causes a guidance speaker (105) to reproduce a vocalization of the audible text read out from the memory (110), and a button illumination control section (136) that illuminates, in synchronization with the vocalization of a sentence included in the audible text vocalized through the guidance speaker (105), operating buttons that correspond to that sentence.

### CROSS REFERENCE TO RELATED APPLICATION

This application is a continuing application, filed under 35 U.S.C. §111(a), of International Application PCT/JP2005/000280, with an International filing date of Jan. 13, 2005, published in Japanese under PCT Article 21(2).

### TECHNICAL FIELD

The present invention relates to an electronic device equipped with multiple operating buttons, which executes operations according to button operations, and a control program that controls operations of the electronic device.

### BACKGROUND ART

In recent years, the growing popularity of mobile phones among users of all ages has given rise to demands for greater usability in mobile phones. In this light, conventionally, a technique has been proposed which, in order to assist a user with button operations of an electronic device such as a mobile phone having multiple buttons, reproduces a vocalization of a text explaining a button operation and illuminates an operating button to be operated (for instance, refer to Patent Documents 1 to 3).

FIG. 1 is an external view of a mobile phone provided with a function for offering guidance on button operations to a user, in addition to a talking function.

A mobile phone 500 shown in FIG. 1 is provided with a talk speaker 501, a display screen 502, and an operating section 503. Furthermore, the operating section 503 is provided with multiple buttons 503a, 503b, . . . , a microphone 504, and a guidance speaker 505.

With this mobile phone 500, talking is achieved using the talk speaker 501 and the microphone 504. In addition, when performing a desired button operation, a user first operates a menu key 503d to cause an operating menu, not shown, which lists names of multiple button operations, to be displayed on the display screen 502, and further operates a direction key 503e to select a name of a desired button operation from the operating menu. As a result of the series of operations, an operation screen 560 corresponding to the desired button operation is displayed on the display screen 502. Furthermore, as the operation screen 560 is displayed on the display screen 502, a vocalization of a text 550 explaining a button operation corresponding to the operation screen 560 is reproduced from the guidance speaker 505. Moreover, during the vocalization of the text 550, operating buttons (in the example shown in FIG. 1, an enter key 503a, a “1” key 503b and a “2” key 503c) to be operated corresponding to the text 550 and the operation screen 560 are illuminated.

Patent Document 1: Japanese Patent Laid-Open No. 2002-142028 (pages 3-4, FIG. 1)

Patent Document 2: Japanese Patent Laid-Open No. 2004-78011 (pages 3-6, FIG. 3)

Patent Document 3: Japanese Patent Laid-Open No. 2004-134942 (pages 4-7, FIG. 1)

### DISCLOSURE OF THE INVENTION

However, with the technique described with reference to FIG. 1, when multiple operating buttons are to be operated as shown therein, all of the buttons to be operated will be simultaneously illuminated for the duration of the vocalization of the text explaining the button operation. As a result, for users such as the elderly who may often experience difficulty when operating multiple operating buttons, a problem may arise in that a user is unable to readily understand which operating button among the multiple illuminated operating buttons the currently vocalized text is referring to.

While the description provided above cites a mobile phone as an example and addresses a problem in that users are unable to readily understand guidance on button operations provided through vocalization of texts and illumination of operating buttons, the same problem may also occur with electronic devices in general which have multiple operating buttons.

The present invention has been made in consideration of the above circumstances, and an object thereof is to provide an electronic device capable of providing a user with easy-to-understand guidance on button operations, and a control program that controls the electronic device.

In order to achieve the above object, an electronic device according to the present invention is an electronic device equipped with multiple operating buttons and executes operations according to button operations, the electronic device including:

a storage section that stores an audible text explaining a button operation;

a text vocalization section that reproduces a vocalization of the audible text read out from the storage section; and

an illumination control section that illuminates an operating button that corresponds to a sentence forming a portion of the audible text in synchronization with the vocalization of that sentence by the text vocalization section.

According to the electronic device of the present invention, in the event that multiple operating buttons are to be operated, each operating button is illuminated by the illumination control section in synchronization with the vocalization of a sentence corresponding to the operating button by the text vocalization section. As a result, a user may easily understand which operating button the guidance offered by the currently vocalized sentence corresponds to. In other words, according to the electronic device of the present invention, users will be provided with easy-to-understand guidance on button operations.

In a preferred embodiment of an electronic device according to the present invention, the storage section stores audible texts into which control codes that control illumination and extinguishing of operating buttons are added,

the text vocalization section vocalizes an audible text read out from the storage section with the exception of the control codes, and hands over one of the control codes to the illumination control section at a timing whereat vocalization has proceeded up to that control code, and

the illumination control section controls illumination and extinguishing of operating buttons based on the control code received from the text vocalization section.

According to an electronic device of this preferred embodiment, for instance, by a simple implementation involving sandwiching a sentence between a control code that illuminates an operating button and a control code that extinguishes the operating button, the sentence will be associated with the operating button, and illumination of the operating button in synchronization with the vocalization of the sentence may be achieved.

Additionally, an embodiment of the electronic device according to the present invention may also be arranged so that: the storage section stores, in addition to the audible text, screen display data associated with the audible text, and

the electronic device includes a screen display section that displays a screen based on screen display data associated with the audible text when the audible text is vocalized by the text vocalization section. Also, in a preferred embodiment of an electronic device provided with the screen display section, the storage section stores screen display data used to display a screen including a display portion associated with an operating button, and

the screen display section changes the display mode of the display portion shown on a display screen, which is associated with the operating button, in synchronization with illumination of the operating button by the illumination control section.

According to the electronic device of this preferred embodiment, a user's understandability towards guidance contents that are described by an audible text may be enhanced by arranging vocalization of audible text to be performed so that, in synchronization with a vocalization of a sentence, an operating button corresponding to that sentence is illuminated and the display mode of a display portion, corresponding to the operating button, on the display screen is changed.

Furthermore, in another preferred embodiment of an electronic device according to the present invention, the storage section is further arranged to store a second control code that controls illumination of an operating button that is independent from an audible text and is different from the control code that controls illumination and extinguishing of the operating button which is added to the audible text, and

the illumination control section controls illumination and extinguishing of an operating button using both the control code added to the audible text and the second control that is independent from the audible text.

According to the electronic device of this preferred embodiment, illumination control of an operating button that differs from illumination control of the operating button performed in synchronization of the vocalization of an audible text may be performed as follows. For example, illumination control may be executed so that, after conclusion of vocalization of the audible text, the operating button that had been illuminated during vocalization is once again illuminated in order to remind the user which operating button should be operated. For another example, illumination control may be executed so that, when there is an operating button that is invariably operated regardless of the contents of the audible text, such as an operating button used to return a current operation screen to an initial screen after a series of button operations, the operating button is invariably illuminated after conclusion of vocalization of the audible text regardless of contents thereof.

Moreover, with respect to this preferred embodiment of an electronic device according to the present invention, a further preferred embodiment is arranged so that: the illumination control section controls illumination and extinguishing of an operating button in accordance with a control code added to an audible text, and after control according to the control code is concluded, the illumination control section controls illumination and extinguishing of the operating button based on a second control code that is independent from the audible text.

In most cases, illumination control of an operating button which differs from illumination control of the operating button performed in synchronization with the vocalization of the audible text, such as the illumination control described above that is performed in order to remind a user or illumination control of an operating button that is invariably operated after a series of button operations, is executed after conclusion of illumination control of the operating button performed in synchronization with such vocalization. According to the electronic device of this further preferred embodiment, illumination control executed after conclusion of illumination control of the operating button performed in synchronization of the vocalization of an audible text may be performed as described above.

Additionally, with the preferred embodiment of an electronic device described above, a further preferred embodiment is arranged so that the electronic device includes: an illumination duration setting section that sets, according to an operation, a duration between illumination and extinguishing of an operating button that is illuminated based on the second control code;

wherein when the operating button is illuminated based on the second control code, the illumination control section extinguishes the operating button after a lapse of the duration set by the illumination duration setting section.

According to the electronic device of this further preferred embodiment, the duration between illumination and extinguishing of an operating button based on the second control code may be arbitrarily set.

Furthermore, with the electronic device according to the present invention, a preferred embodiment of the electronic device includes: an illumination mode setting section that sets, according to operations, an illumination control mode that performs illumination control of an operating button using the illumination control section in synchronization with a vocalization of an audible text by the text vocalization section, and an illumination prohibition mode that prohibits illumination control,

wherein the illumination control section operates only when the illumination control mode is set by the illumination mode setting section. Another preferred embodiment is arranged so that the electronic device includes:

a vocalization mode setting section that sets, according to operations, a vocalization control mode that performs vocalization of an audible text using the text vocalization section and a vocalization prohibition mode that prohibits vocalization;

wherein the text vocalization section operates only when the vocalization control mode is set by the vocalization mode setting section.

According to an electronic device of these embodiments, a user may preferentially set whether the electronic device performs illumination of an operating button in synchronization with a vocalization of the audible text, or whether the electronic device performs vocalization of the audible text.

Moreover, in order to achieve the above object, a control program according to the present invention enables an electronic device equipped with multiple operating buttons and which executes operations according to button operations to operate as an electronic device that includes:

a storage section that stores an audible text explaining a button operation;

a text vocalization section that reproduces a vocalization of the audible text read out from the storage section; and

an illumination control section that illuminates an operating button that corresponds to a sentence forming a portion of the audible text in synchronization with the vocalization of that sentence by the text vocalization section.

According to the control program of the present invention, the electronic device may be easily operated as an electronic device that provides a user with easy-to-understand guidance on button operations.

To avoid repetition, only a basic embodiment of the control program of the present invention will be described. However, it should be noted that the control program, as defined by the present invention, includes various embodiments corresponding to the various embodiments of the electronic devices described above.

As seen, the present invention provides an electronic device capable of providing a user with easy-to-understand guidance on button operations, and a control program that controls the electronic device.

### BRIEF DESCRIPTION OF THE DRAWINGS

FIG. 1 is an external view of a mobile phone provided with a function for offering guidance on button operations to a user, in addition to a talking function.

FIG. 2 is an external view of a mobile phone that is an embodiment of an electronic device according to the present invention.

FIG. 3 is a hardware block diagram representing the mobile phone shown in FIG. 2.

FIG. 4 is a schematic diagram showing a first control program that is a first embodiment of a control program according to the present invention, stored in a memory 110 shown in FIG. 3.

FIG. 5 is a diagram showing an operation screen for setting an illumination duration of an operating button.

FIG. 6 is a diagram showing an operation screen for setting an illumination mode.

FIG. 7 is a diagram showing an operation screen for setting a vocalization mode.

FIG. 8 is a flowchart showing processing flows of vocalization and illumination control of an operating button.

FIG. 9 is a diagram showing guidance data explaining contents of guidance on button operations corresponding to the settings of an alarm clock function shown in FIG. 2.

FIG. 10 is a diagram showing examples of control codes.

FIG. 11 is a schematic diagram showing operations of the mobile phone executed based on the guidance data shown in FIG. 9.

FIG. 12 is a diagram showing guidance data to which a second control code is added.

FIG. 13 is a schematic diagram showing operations of the mobile phone executed based on the guidance data shown in FIG. 12 in a case in which the vocalization mode is set to vocalization prohibition mode.

FIG. 14 is a diagram showing an example of guidance data to which a second control code is added which differs from the example shown in FIG. 12.

FIG. 15 is a schematic diagram showing operations of the mobile phone executed based on the guidance data shown in FIG. 14.

FIG. 16 is an external view of a second mobile phone that is a second embodiment of an electronic device according to the present invention.

FIG. 17 is a schematic diagram showing a second control program that is a second embodiment of a control program according to the present invention, stored in a memory of the second mobile phone shown in FIG. 16.

FIG. 18 is a flowchart showing processing flows of vocalization and illumination control of an operating button.

FIG. 19 is a schematic diagram showing operations of the mobile phone executed based on the guidance data shown in FIG. 9.

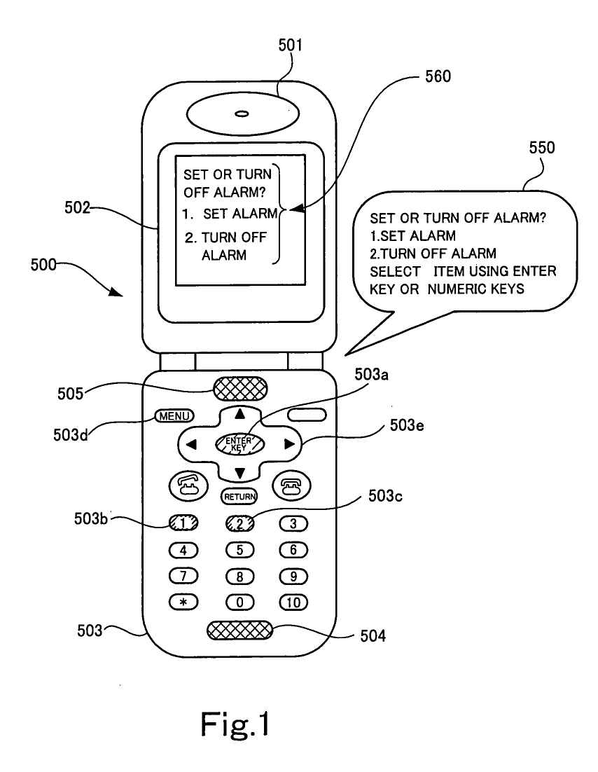

### BEST MODE FOR CARRYING OUT THE INVENTION

Embodiments of the present invention will now be described with reference to the accompanying drawings.

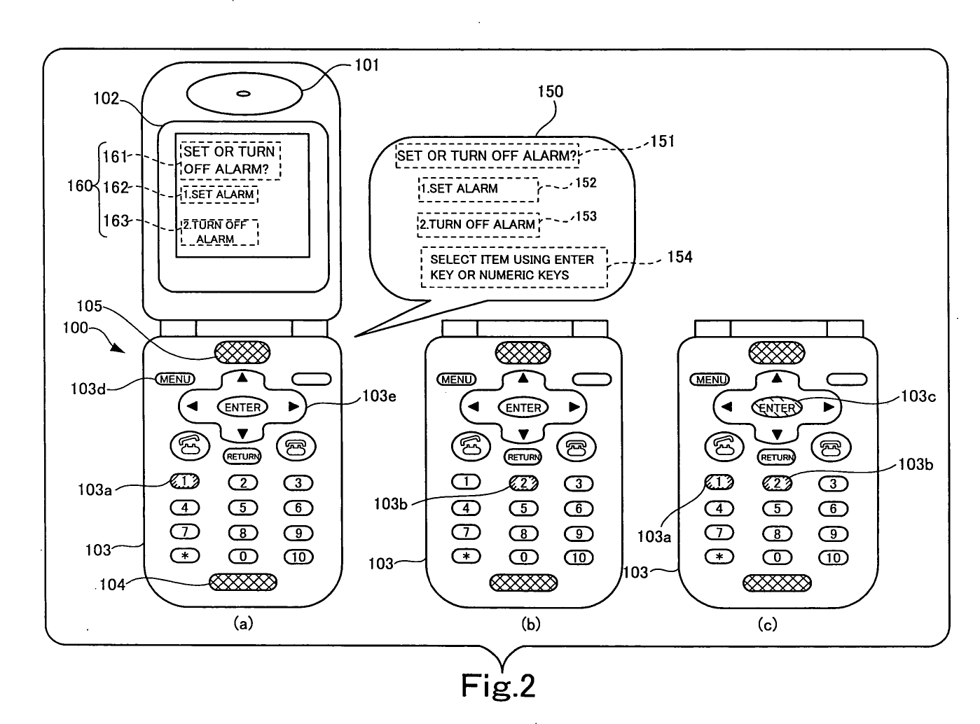

FIG. 2 is an external view of a first mobile phone that is a first embodiment of an electronic device according to the present invention.

The first mobile phone 100 shown in FIG. 2 has a function for providing a user with guidance on button operations of the first mobile phone 100 in addition to a talking function, and is provided with a talk speaker 101, a display screen 102, and an operating section 103. Furthermore, the operating section 103 is provided with multiple operating buttons 103a, 103b, . . . , a microphone 104, and a guidance speaker 105. Part (a) of FIG. 2 provides an external view of the entire first mobile phone 100, while parts (b) and (c) only show the operating section 103.

With the first mobile phone 100, talking is performed using the talk speaker 101 and the microphone 104. In addition, when the user first operates a menu key 103d to have an operating menu, not shown, having a list of names of multiple button operations, displayed on a display screen 102, and selects the name of a desired button operation by operating a direction key 103e, an operation screen 160 corresponding to the desired button operation is shown on the display screen 102. Furthermore, a vocalization of a text 150 explaining a button operation corresponding to the operation screen 160 is reproduced from the guidance speaker 105.

FIG. 2 shows the text 150 describing a button operation related to setting an alarm clock function as an example of a text that is vocalized by the first mobile phone 100. The text includes four sentences, namely, a first sentence 151: “Set or turn off alarm?”; a second sentence 152: “1. Set alarm”; a third sentence 153: “2. Turn off alarm”; and a fourth sentence 154: “Select item using enter key or numeric keys”. In addition, FIG. 2 shows an operation screen 160 corresponding to the button operation related to settings of an alarm clock function as an example of an operation screen that is displayed on the display screen 102. The operation screen 160 includes three display portions, namely, a first display portion 161 of “Set or turn off alarm?”; a second display portion 162 of “1. Set alarm”; and a third display portion 163 of “2. Turn off alarm”.

With the first mobile phone 100, during vocalization of the text 150, a “1” key 103a corresponding to the second sentence 152 that is operated when setting the alarm clock function is illuminated when the second sentence 152 is vocalized, as shown in part (a) of FIG. 2. In addition, a “2” key 103b corresponding to the third sentence 153 that is operated when turning off the alarm clock function is illuminated when the third sentence 153 is vocalized, as shown in part (b) of FIG. 2. Furthermore, the three operating buttons (the “1” key 103a, the “2” key 103b and an enter key 103c) that are related to settings of the alarm clock function, which correspond to the fourth sentence 154, are illuminated when the fourth sentence is vocalized, as shown in part (c) of FIG. 2.

With the first mobile phone 100, even in the event that multiple operating buttons are to be operated, each operating button is illuminated in synchronization with the vocalization of a sentence corresponding to the operating button. As a result, a user may easily understand which operating button the operation described by the guidance offered by the currently vocalized sentence corresponds to.

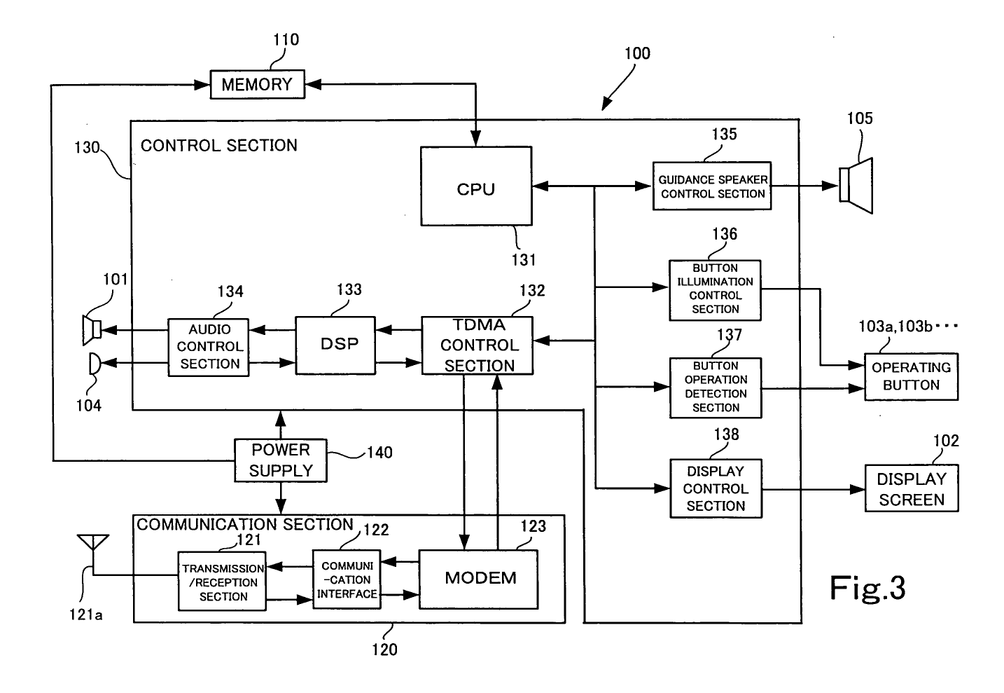

FIG. 3 is a hardware block diagram representing the first mobile phone shown in FIG. 2.

The first mobile phone 100 includes a memory 110, a communication section 120, a control section 130, and a power source 140. In addition, FIG. 3 shows the talk speaker 101, the display screen 102, the operating buttons 103a, 103b, . . . , the microphone 104, and the guidance speaker 105 for which exterior views are shown in FIG. 2. In addition, the communication section 120 has a transmission/reception section 121, a communication interface 122, and a MODEM (MOdulator-DEModulator) 123, while the control section 130 includes a CPU 131, a TDMA (Time Division Multiple Access) control section 132, a DSP (Digital Signal Processor) 133, an audio control section 134, a guidance speaker control section 135, a button illumination control section 136, a button operation detection control section 137 and a display control section 138.

A program that controls operations of the first mobile phone 100 and the first control program that is a first embodiment of the control program according to the present invention are stored in the memory 100. The first control program will be described later. In addition, the memory 110 also stores guidance data, to be described later, which describes contents of guidance on button operations. The memory 110 is configured by a ROM, an E²PROM that is a writeable ROM, or a RAM and the like.

Furthermore, the power source 140 supplies power to components of the first mobile phone 100.

At the communication section 120, a signal transmission/reception function of the first mobile phone 100 is carried out as described below.

The transmission/reception section 121 executes transmission/reception of signals via an antenna 121a.

The communication interface 122 executes delivery of signals to the transmission/reception section 121 in conformity with a predetermined communication standard.

In addition, the MODEM 123 executes decoding of signals encoded for communication which are received by the transmission/reception section 121 and delivered via the communication interface 122, and encoding of audio signals generated through sound collection at the microphone 104 and delivered via the audio control section 134, the DSP 133, and the TDMA control section 132.

At the control section 130, a control function of the first mobile phone 100 is carried out as described below.

The CPU 131 of the control section 130 controls operations of the entire first mobile phone 100.

The TDMA control section 132 performs modulation processing in conformity with the so-called TDMA method, which is a communication method in which multiple mobile phones take turns using a single frequency for short periods of time, on signals acquired by the microphone 104 and sent via the audio control section 134 and the DSP 133, and demodulation processing in conformity with the TDMA method on signals sent from the MODEM 123.

The DSP 133 performs signal processing such as filtering processing on audio signals delivered from the TDMA control section 132 or audio signals to be delivered to the TDMA control section 132.

The audio control section 134 delivers audio signals to the talk speaker 101 and receives audio signals from the microphone 104.

The guidance speaker control section 135 executes delivery of audio signals to the guidance speaker 105 based on instructions from the CPU 131.

The button illumination control section 136 executes illumination and extinguishing of operational buttons 103a, 103b, . . . based on instructions from the CPU 131.

The button operation detection section 137 sends operation signals corresponding to operations performed on each operating button 103a, 103b, . . . to the CPU 131.

The display control section 138 displays images on the display screen 102 based on instructions from the CPU 131.

As seen, in the first mobile phone 100 for which an overview has been described with reference to FIG. 3, the CPU 131 controls each component of the first mobile phone 100 based on a program stored in the memory 110.

Hereinafter, only characteristic portions of the present invention will be described. First, a description will be provided on a first control program that is a first embodiment of a control program according to the present invention.

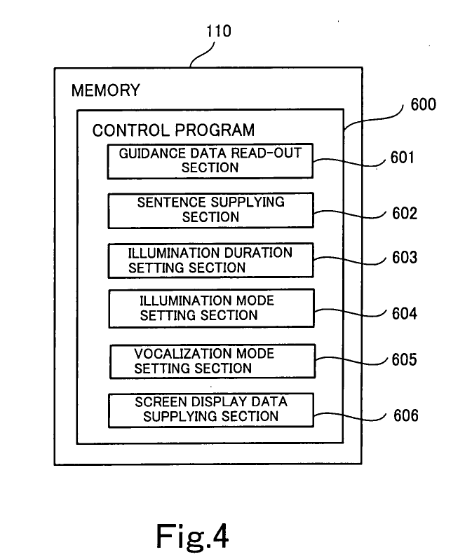

FIG. 4 is a schematic diagram showing the first control program that is a first embodiment of a control program according to the present invention, which is stored in the memory 110 shown in FIG. 3.

A first program 600 stored in the memory 110 is provided with a guidance data read-out section 601, a sentence supplying section 602, an illumination duration setting section 603, an illumination mode setting section 604, a vocalization mode setting section 605, and a screen display data supplying section 606. In the following description, reference will be made to the elements shown in FIGS. 2 and 3 without specifying figure numbers.

First, as described earlier, the memory 110 also stores guidance data describing contents of guidance on button operations. Basically, guidance data consists of screen display data, for which an example is shown in FIG. 2, that is used to display an operation screen corresponding to a button operation, and an audible text in which control codes that illuminates or extinguishes the operating buttons 103a, 103b, . . . is added into a text explaining a button operation. In addition, guidance data stored in the memory 110 also includes data to which is added a second control code that illuminates an operating button independently from the audible text. Details of the guidance data and control codes will be described later.

As described earlier, when the user selects a desired button operation by operating the menu key 103d or the direction key 103e, the guidance data read-out section 601 that is a program component of the control program 600 shown in FIG. 4 is executed by the CPU 131, and guidance data corresponding to the desired button operation is read out from the memory 110. In the present embodiment, the storage section as defined by the present invention is configured by the portion of the memory 110 storing the guidance data, the guidance data read-out section 601, and the CPU 131 that executes the guidance data read-out section 601.

In addition, when the sentence supplying section 602 that is a program component is executed by the CPU 131, the audible text is retrieved from the guidance data. Then, the sentence supplying section 602 sequentially sends sentences constituting the audible text with the exception of the control codes to the guidance speaker control section 135. The guidance speaker control section 135 causes the guidance speaker 105 to reproduce a vocalization of the sentences. The sentence supplying section 602 also assumes the role of delivering control codes, and up to immediately before one control code in the audible text, the control code is handed over to the button illumination control section 136 at a timing whereat a sentence was sent to the guidance speaker control section 135. The button illumination control section 136 illuminates or extinguishes the operating buttons 103a, 103b, . . . according to the delivered control code. When the last sentence of the audible text is sent and vocalization of the last sentence is concluded, the guidance speaker control section 135 performs vocalization conclusion notification indicating that the vocalization of the audible text has been concluded. The vocalization conclusion notification is used in processing that is performed to notify the user via the display screen 102 that the vocalization of the text has been concluded. The processing of vocalization conclusion notification to the user via the display screen 102 will be described later. In the present embodiment, an example of the text vocalization section as defined by the present invention is configured by the sentence supplying section 602 as a program component, the CPU 131 that executes the sentence supplying section 602, the guidance speaker control section 135 and the guidance speaker 105. Additionally, in the present embodiment, an example of the illumination control section as defined by the present invention is configured by the button illumination control section 136.

As described earlier, guidance data stored in the memory 110 also includes data, to which is added the second control code that illuminates an operating button, which is independent from the audible text. In the present embodiment, when the second control code has been added to the guidance data read out by the guidance data read-out section 601, second control code transmission processing in which the second control code is transmitted to the button illumination control section 136 after all vocalization of the audible text is concluded, as well as illumination control, executed by the button illumination control section 136 that receives the second control code, in which an operating button corresponding to the second control code is illuminated for an illumination duration set through the operations described below, are performed. Here, the second control code transmission processing and the illumination control with respect to the second control code will be described later, and instead, setting of an illumination duration will now be described.

In the present embodiment, when the user operates the menu key 103d or the direction key 103e to select a button operation for setting an illumination duration, the screen display data supplying section 606 executed by the CPU 131 causes an operation screen corresponding to the button operation to be displayed on the display screen 102. Operations of the screen display data supplying section 606 related to the displaying of an operation screen will also be described later.

FIG. 5 is a diagram showing an operation screen for setting an illumination duration of an operating button.

The operation screen 180 shown in FIG. 5 consists of a display portion 181 that prompts the user to set an illumination duration of an operating button to a duration of 1-10 seconds, and a display portion 182 that displays a currently-set illumination duration. When the user operates the ten numeric keys or the direction key 103e shown in FIG. 2 during setting of an illumination duration, the button operation detection section 137 detects such operations, the CPU 131 executes the illumination duration setting section 603 that is a program component, and the illumination duration setting section 603 sets the illumination duration to a duration corresponding to the detection results. In this description, an operation of the direction key 103e means that the direction key 103e is either operated to an upper side, as seen from the user, to increment a numeral of a display portion 187 that displays an illumination duration by one, or operated to a lower side to decrement the numeral by one. The illumination duration set at this point is stored in the memory 110. When the button illumination control section 136 executes illumination control with respect to the second control code, the set illumination duration is read out from the memory 110 to be used for illumination control. Usage of the illumination duration will be described later in conjunction with the description on illumination control. In the present embodiment, an example of the illumination duration setting section as defined by the present invention is configured by the illumination duration setting section 603 as a program component, the CPU 131 that executes the illumination duration setting section 603, operating buttons that are operated when setting an illumination duration, and the button operation detection section 137.

Next, returning to FIG. 4, a description will be provided on processing when setting the illumination mode to either an illumination control mode that performs illumination control of an operating button or an illumination prohibition mode that prohibits illumination control.

When the user operates the menu key 103d or the direction key 103e to select a button operation for setting an illumination mode, the screen display data supplying section 606 executed by the CPU 131 causes an operation screen corresponding to the button operation to be displayed on the display screen 102.

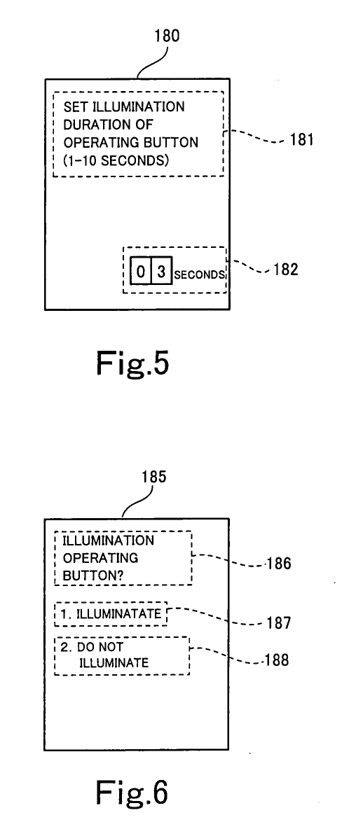

FIG. 6 is a diagram showing an operation screen for setting an illumination mode.

The operation screen 185 shown in FIG. 6 consists of a display portion 186 that inquires whether the user wishes to illuminate an operating button, a display portion 187 that prompts the user to operate the “1” key 103a in the event that the operating button will be illuminated, and a display portion 188 that prompts the user to operate the “2” key 103b in the event that the operating button will not be illuminated. The illumination mode at the time of display of the operation screen 185 is the illumination mode set prior to the time of display. When the user operates the “1” key 103a, the button operation detection section 137 detects the operation, the CPU 131 executes the illumination mode setting section 604 that is a program component, and in response to the detection results, the illumination mode setting section 604 sets the illumination mode to the illumination control mode. In addition, when the user operates the “2” key 103b, the button operation detection section 137 detects the operation, and in response to the detection results, the illumination mode setting section 604 sets the illumination mode to the illumination prohibition mode. The illumination control mode or the illumination prohibition mode set in this manner is stored in the memory 110. In the present embodiment, an example of the illumination mode setting section as defined by the present invention is configured by the illumination mode setting section 604 as a program component, the CPU 131 that executes the illumination mode setting section 604, operating buttons that are operated when setting an illumination mode, and the button operation detection section 137.

Next, returning to FIG. 4, a description will be provided on processing when setting the vocalization mode to either a vocalization control mode that performs vocalization of an audible text or a vocalization prohibition mode that prohibits vocalization.

When the user operates the menu key 103d or the direction key 103e to select a button operation for setting a vocalization mode, the screen display data supplying section 606 executed by the CPU 131 causes an operation screen corresponding to the button operation to be displayed on the display screen 102.

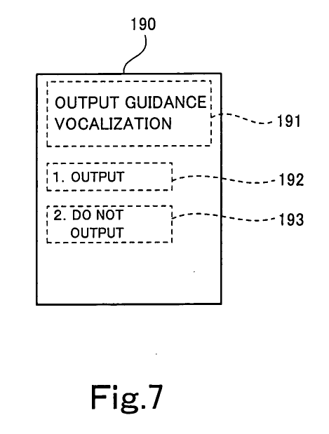

FIG. 7 is a diagram showing an operation screen for setting a vocalization mode.

The operation screen 190 shown in FIG. 7 consists of a display portion 191 that inquires whether the user wishes to output a guidance vocalization of an audible text that describes a button operation, a display portion 192 that prompts the user to operate the “1” key 103a in the event that the vocalization will be outputted, and a display portion 193 that prompts the user to operate the “2” key 103b in the event that the vocalization will not be outputted. The vocalization mode at the time of display of the operation screen 190 is the vocalization mode set prior to the time of display. When the user operates the “1” key 103a, the button operation detection section 137 detects the operation, the CPU 131 executes the vocalization mode setting section 605 that is a program component, and in response to the detection results, the vocalization mode setting section 605 sets the vocalization mode to the vocalization control mode. In addition, when the user operates the “2” key 103b, the button operation detection section 137 detects the operation, and in response to the detection results, the vocalization mode setting section 605 sets the vocalization mode to the vocalization prohibition mode. The vocalization mode set in this manner is stored in the memory 110. In the present embodiment, an example of the vocalization mode setting section as defined by the present invention is configured by the vocalization mode setting section 605 as a program component, the CPU 131 that executes the vocalization mode setting section 605, operating buttons that are operated when setting a vocalization mode, and the button operation detection section 137.

Next, once again returning to FIG. 4, a description will be given on operations related to displaying of an operation screen of the screen display data supplying section 606 in the event that the CPU 131 executes the screen display data supplying section 606. The screen display data supplying section 606 also performs the roles of executing transmission processing of the second control code, and executing notification processing of vocalization conclusion to the user via the display screen 102. Transmission processing of the second control code and notification processing of vocalization conclusion to the user via the display screen 102 will also be described below.

First, when the user selects a desired button operation by operating the menu key 103d or the direction key 103e, the guidance data read-out section 601 is executed by the CPU 131, and the guidance data read-out section 601 reads out guidance data corresponding to the desired button operation from the memory 110. Next, the CPU 131 executes the screen display data supplying section 606 that is a program component, and the screen display data supplying section 606 extracts screen display data for displaying an operation screen corresponding to the button operation from the guidance data. The screen display data supplying section 606 supplies the screen display data to the display control section 138 which then displays the operation screen based on the screen display data on the display screen 102.

In addition, as described earlier, in the present embodiment, when vocalization of the last sentence of the audible text is concluded, a vocalization conclusion notification indicating that the vocalization of the audible text has concluded is performed through the guidance speaker control section 135. In the event that a second control code is added to the guidance data, the screen display data supplying section 606 executed by the CPU 131 executes, in response to the vocalization conclusion notification, second control code transmission processing to deliver the second control code to the button illumination control section 136. Upon receiving the second control code, the button illumination control section 136 executes illumination control that illuminates operating buttons 103a, 103b, corresponding to the second control code or, in other words, executes illumination control with respect to the second control code. Furthermore, when delivering the second control code to the button illumination control section 136, the screen display data supplying section 606 reads out the illumination duration set by the illumination duration setting section 603 from the memory 110, and sets a timer to the illumination duration. The timer monitors an elapsed time from the illumination of the operating buttons 103a, 103b, . . . , and outputs a timer expiration event when the elapsed time reaches the set illumination duration. Based on the second control code, the screen display data supplying section 606 also generates a control code that extinguishes the operating buttons 103a, 103b, corresponding to the second control code before the timer expiration event is outputted. The screen display data supplying section 606 delivers this control code to the button illumination control section 136 at the timing of output of the timer expiration event, and the button illumination control section 136 extinguishes the operating buttons 103a, 103b, . . . .

Moreover, the display control section 138 notifies conclusion of vocalization to the user via the display screen 102 at the timing of output of the timer expiration event when the second control code transmission processing is performed by the screen display data supplying section 606 executed by the CPU 131, and at the timing of the vocalization conclusion notification when the second control code transmission processing is not executed.

In the present embodiment, an example of the screen display section as defined by the present invention is configured by the screen display data supplying section 606 that is a program component, the CPU 131 that executes the screen display data supplying section 606, the display control section 138, and the display screen 102.

Next, details of audible text vocalization and illumination control of operating buttons will be described. In the following description, reference will be made to the components shown in FIGS. 2, 3 and 4 without specifying figure numbers.

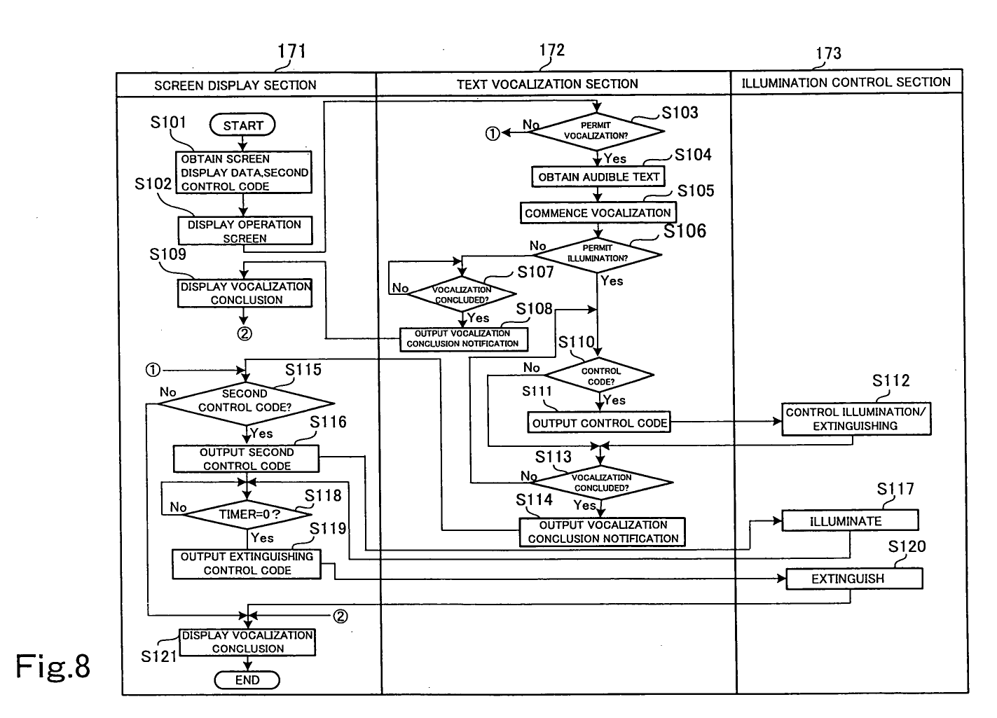

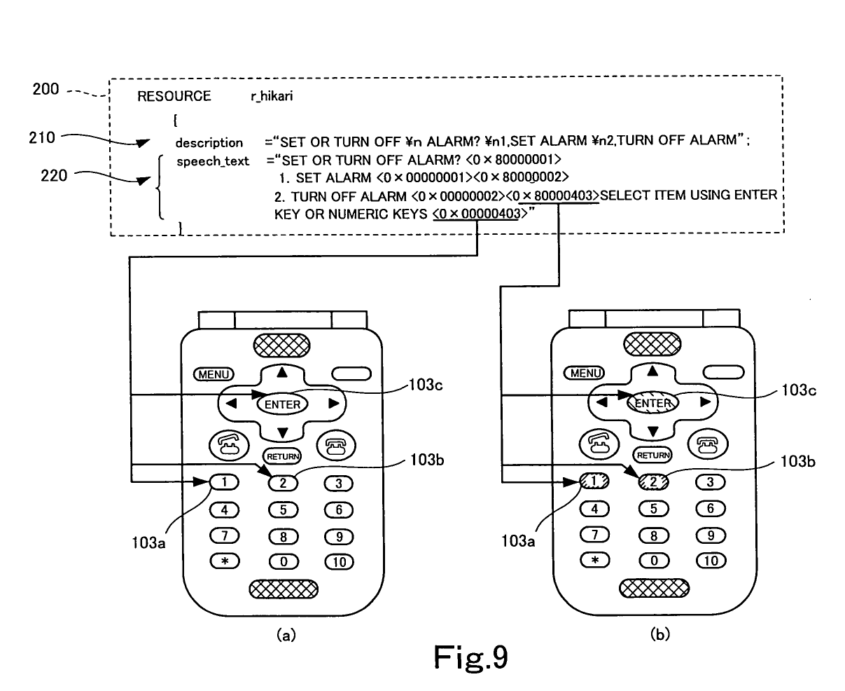

FIG. 8 is a flowchart showing processing flows of vocalization and illumination control of an operating button.

The flowchart shown in FIG. 8 depicts a flow of processing executed by the CPU 131 according to the control program 600. In FIG. 8, for better understanding of the processing, reference numerals “171”, “172” and “173” are respectively assigned to the screen display portion that is configured to include execution of the control program 600 shown in FIG. 4, the text vocalization section, and the illumination control section, and the processing flow is represented by flows of processing that are respectively executed by the screen display section 171, the text vocalization section 172 and the illumination control section 173.

The processing represented by the flowchart shown in FIG. 8 commences when the user operates the menu key 103d or the direction key 103e to select a button operation, as described above. Upon commencement of processing, the screen display section 171 reads out guidance data corresponding to the button operation from the memory 110, and extracts screen display data from the guidance data (step S101). Additionally, in the processing of step S101, when the guidance data contains the second control code, the screen display section 171 also extracts the second control code. The screen display section 171 displays an operation screen corresponding to the screen display data on the display screen 102 (step S102). Next, the text vocalization section 172 judges whether the vocalization mode is the vocalization control mode or the vocalization prohibition mode (step S103). If the vocalization mode is the vocalization control mode (a “Yes” judgment in step S103), the text vocalization section 172 extracts the audible text from the guidance data (step S104). On the other hand, if the vocalization mode is the vocalization prohibition mode (a “No” judgment in step S103), the processing proceeds to step S116, which will be described later.

Once the audible text is extracted, the text vocalization section 172 removes control codes from the audible text, and vocalization processing commences in which sentences constituting the remaining audible text are sequentially vocalized (step S105).

After commencement of vocalization processing, the text vocalization section 172 judges whether the illumination mode is the illumination control mode or the illumination prohibition mode (step S106). If the illumination mode is the illumination prohibition mode (a “No” judgment in step S106), the text vocalization section 172 repeats judgment processing on whether vocalization processing has been concluded (step S107) throughout the duration of vocalization processing (a “No” judgment in step S107), and once vocalization processing has been concluded (a “Yes” judgment in step S107), the text vocalization section 172 transmits a vocalization conclusion notification indicating conclusion of vocalization processing to the screen display section 171 (step S108). Upon receiving the vocalization conclusion notification, the screen display section 171 notifies the user of vocalization conclusion via the display screen 102 (step S109), thereby concluding the processing represented by the flowchart shown in FIG. 8.

On the other hand, if the judgment processing of step S106 judges that the illumination control mode is the illumination control mode (a “Yes” judgment in step S106), the text vocalization section 172 executes the following processing (step S110).

In the processing of step S110, judgment is made on whether vocalization processing has proceeded to immediately prior to the control code in the audible text. In the event that the vocalization processing has not proceeded to immediately prior to the control code (a “No” judgment in step S110), the processing proceeds to step S113, which will be described later. On the other hand, in the event that the vocalization processing has proceeded to immediately prior to the control code (a “Yes” judgment in step S110), the text vocalization section 172 sends the control code to the illumination control section 173 (step S111). As described later, the control code is used to illuminate or extinguish an operating button corresponding to a sentence immediately following the control code in the audible text. Upon receiving the control code, the illumination control section 173 either illuminates or extinguishes the operating button according to the control code (step S112).

Subsequently, the text vocalization section 172 judges whether vocalization processing has been concluded (step S113), and if vocalization processing is ongoing (a “No” judgment in step S113), the process returns to before step S110, and repeats the processing of steps S110 to S112. In the event that vocalization processing has been concluded (a “Yes” judgment in step S113), the text vocalization section 172 sends the vocalization conclusion notification to the screen display section 171 (step S114).

Upon receiving the vocalization conclusion notification, the screen display section 171 judges whether the data extracted in the processing performed in step S101 contains the second control code (step S115), and if so (a “Yes” judgment in step S115), the screen display section 171 outputs the second control code to the illumination control section 173 (step S116). The second control code is a control code, which illuminates an operating button, which is independent from the audible text. Upon receiving the second control code, the illumination control section 173 illuminates an operating button corresponding to the second control code (step S117).

In addition, after outputting the second control code in the processing performed in step S116, the screen display section 171 sets the timer to an illumination duration set by the illumination duration setting section 603 shown in FIG. 4, and the timer monitors an elapsed time from the illumination of the operating buttons performed in the processing of step S117 (step S118). This monitoring is continued until the elapsed time reaches the set illumination duration (a “No” judgment in step S118). When the elapsed time reaches the set illumination duration (a “Yes” judgment in step S118), the timer outputs a timer expiration event. In response to the timer expiration event, the screen display section 171 outputs an extinguishing control code that extinguishes the operating button that was illuminated in the processing of step S117 to the illumination control section 173 (step S119). Upon receiving the extinguishing control code, the illumination control section 173 extinguishes the illuminated operating button (step S120). After the screen display section 171 notifies the user of vocalization conclusion via the display screen 102 (step S121), the processing represented by the flowchart shown in FIG. 8 is concluded.

In addition, when the second control code is not present (a “No” judgment in step S115), the processing of steps S116 to S119 is omitted, and after notifying the user of vocalization conclusion via the display screen 102 in the processing of step S121, the processing represented by the flowchart shown in FIG. 8 is concluded.

According to the first mobile phone 100 described above with reference to FIGS. 3 to 8, as described using the example shown in FIG. 2, when an audible text explaining a button operation is vocalized, operating buttons corresponding to a sentence currently being vocalized is illuminated in synchronization with the vocalization.

Next, details of guidance data used by the first mobile phone 100 will be described using guidance data explaining contents of guidance on button operations corresponding to settings of the alarm clock function shown in FIG. 2 as an example of guidance data.

FIG. 9 is a diagram showing guidance data explaining contents of guidance on button operations corresponding to the settings of the alarm clock function shown in FIG. 2.

Guidance data 200 shown in FIG. 9 consists of screen display data 210 that is used to display the operation screen 160 shown in FIG. 2, and a guidance text 220 in which six control codes that illuminate or extinguish operating buttons are added into a text explaining a button operation.

In the audible text 220, a control code “0x80000001” that illuminates the “1” key 103a is added before the sentence “1. Set alarm” corresponding to the “1” key 103a, and a control code “0x00000001” that extinguishes the “1” key 103a is added after the same sentence. Similarly, control codes “0x80000002” and “0x00000002” that respectively illuminates and extinguishes the “2” key 103b are respectively added before and after the sentence “2. Turn off alarm” corresponding to the “2” key 103b. Furthermore, a control code “0x80000403” that simultaneously illuminates the three operating buttons, namely, the enter key 103c, the “1” key 103a and the “2” key 103b, and a control code “0x00000403” that simultaneously extinguishes the three operating buttons are respectively added before and after the sentence “Select item using enter key or numeric keys”.

Also, as an example of illumination and extinguishing of operating buttons 103a, 103b, corresponding to the control codes, part (a) of FIG. 9 shows the three operating buttons, namely, the enter key 103c, the “1” key 103a and the “2” key 103b illuminated in response to the control code “0x80000403” that simultaneously illuminates the three operating buttons, namely, the enter key 103c, the “1” key 103a and the “2” key 103b, while part (b) of FIG. 9 shows the three operating buttons, namely, the enter key 103c, the “1” key 103a and the “2” key 103b extinguished in response to the control code “0x00000403” that simultaneously extinguishes the three operating buttons, namely, the enter key 103c, the “1” key 103a and the “2” key 103b.

Details of the control codes will now be described.

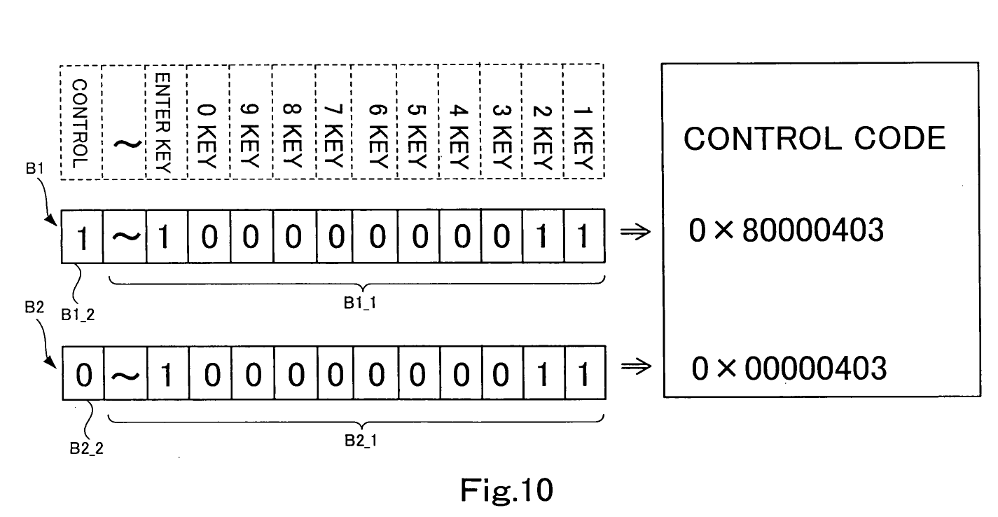

FIG. 10 is a diagram showing examples of control codes.

As examples of control codes, FIG. 10 shows the control code “0x80000403” that simultaneously illuminates the three operating buttons, and the control code “0x00000403” that simultaneously extinguishes the three operating buttons. Although the control codes are shown in FIG. 10 in hexadecimal notation, in reality, the control codes are binaries in which one bit is respectively associated to each of the multiple operating buttons of the first mobile phone 100.

The two binaries B1 and B2 respectively corresponding to the two control codes shown in FIG. 10 both have operating button instruction portions B1_1 and B2_1 which instruct an operating button to be controlled, and control portions B1_2 and B2_2 which instruct either illumination or extinguishing of the operating button.

The operating button instruction portions B1_1 and B2_1 are arrays of multiple bits respectively having one-to-one correspondence to each operating button. In this case, “1” is associated to operating buttons to be controlled, while “0” is associated to other operating buttons. Additionally, the control portions B1_2 and B2_2 respectively consist of one bit, in which “1” is associated to illumination and “0” is associated to extinguishing.

In the present embodiment, illumination or extinguishing of operating buttons to be controlled are performed based on such control codes.

Next, operations of the first mobile phone 100 executed based on the guidance data 200 shown in FIG. 9 will be described. In the same manner as with FIG. 8, operations of the first mobile phone 100 will be described through the respective operations of the screen display portion 171 that is configured to include execution of the control program 600 described earlier, the text vocalization section 172, and the illumination control section 173. Additionally, in the following description, reference will be made to the elements shown in FIGS. 2 and 3 and the guidance data 200 shown in FIG. 9 without specifying figure numbers.

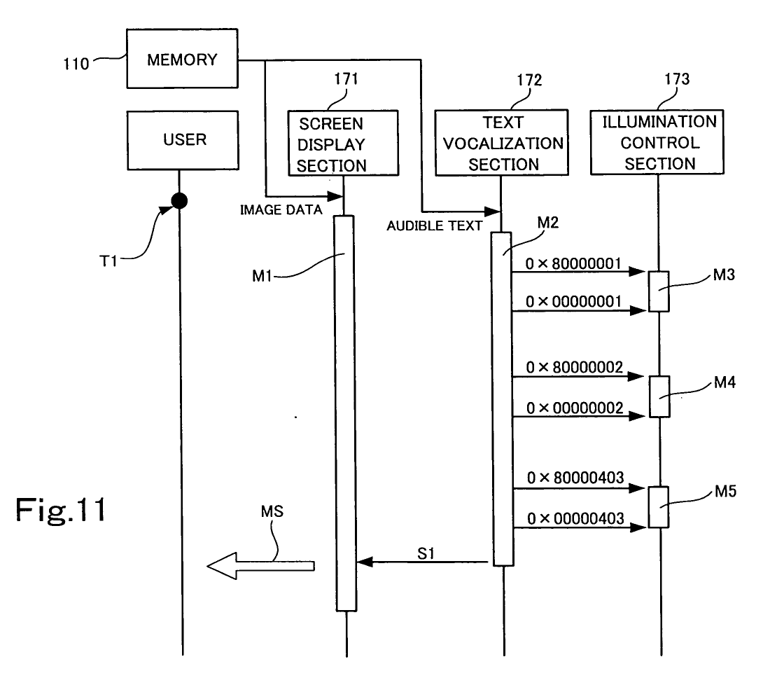

FIG. 11 is a schematic diagram showing operations of the mobile phone executed based on the guidance data shown in FIG. 9.

As described above, at a time point T1 whereat the user operates the first mobile phone 100 with the intention of setting the alarm clock function, the guidance data 200 is read out from the memory 110, the screen display data 210 is handed over to the screen display section 171, and the audible text 220 is handed over to the text vocalization section 172.

The screen display section 171 executes display M1 of an operation screen 160 corresponding to the screen display data 210. In addition, the text vocalization section 172 removes control codes from the audible text 220, and executes vocalization processing M2 in which the remaining sentences of the audible text 220 are sequentially vocalized.

Subsequently, when the vocalization of the audible text 220 proceeds to immediately before the sentence “1. Set alarm”, the text vocalization section 172 sends the control code “0x80000001” that illuminates the “1” key 103a to the illumination control section 173, which in turn executes illumination M3 of the “1” key 103a. When the vocalization proceeds to immediately before the sentence “2. Turn off alarm”, the text vocalization section 172 now sends the control code “0x00000001” that extinguishes the “1” key 103a and a control code “0x80000002” that illuminates the “2” key 103b to the illumination control section 173, which in turn concludes (extinguishes) illumination M3 of the “1” key 103a and executes illumination M4 of the “2” key 103b. Furthermore, when the vocalization proceeds to immediately before the sentence “Select item using enter key or numeric keys”, the text vocalization section 172 sends the control code “0x00000002” that extinguishes the “2” key 103b and a control code “0x00000403” that simultaneously illuminates the “1” key 103a, the “2” key 103b and the enter key 103c to the illumination control section 173, which in turn concludes (extinguishes) illumination M4 of the “2” key 103b and executes simultaneous illumination M5 of the three operating buttons. Next, when vocalization of the sentences is concluded, the text vocalization section 172 sends the control code “0x80000403” that simultaneously illuminates the three operating buttons to the illumination control section 173, which in turn concludes (extinguishes) illumination M5 of the three operating buttons. At a timing of conclusion of the vocalization, the text vocalization section 172 sends a vocalization conclusion notification S1 indicating that the vocalization of the audible text has been concluded to the screen display section 171. At a timing of reception of the vocalization conclusion notification S1, the screen display section 171 executes notification processing MS of vocalization conclusion to the user via the display screen 102.

Next, guidance data to which the second control code is added that is different from the guidance data 200 shown in FIG. 9 will be exemplified, and operations of the first mobile phone 100 corresponding to this guidance data will be described.

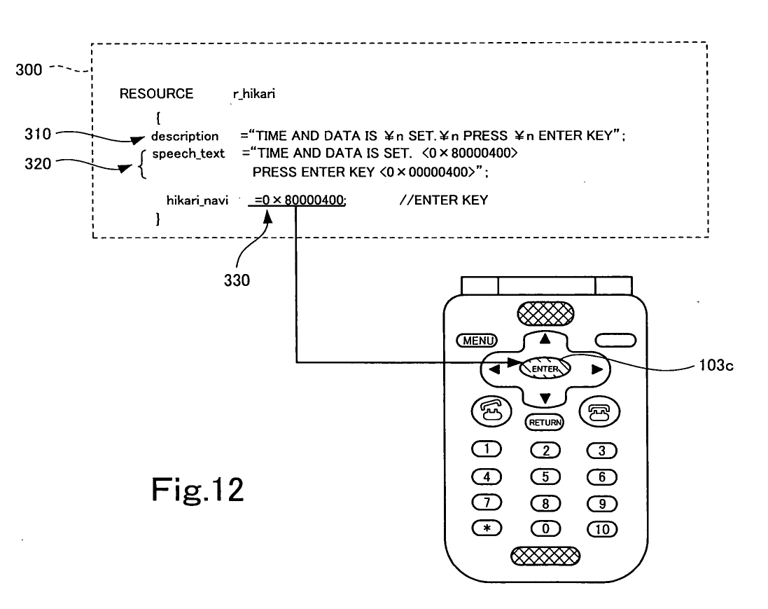

FIG. 12 is a diagram showing guidance data to which a second control code is added.

Guidance data 300 shown in FIG. 12 describes a button operation for confirming a set time and date, and is provided with screen display data 310 and an audible text 320 corresponding to this button operation. A second control code 330 that illuminates an operating button independently from the audible text 320 has been added to the audible data 300. In the example shown in FIG. 12, the second control code 330 is a code used to illuminate the enter key 103c, which is illuminated or extinguished according to the two control codes added to the audible text 320, independently from the audible text 320.

As described above, with the first mobile phone 100, there are cases in which the vocalization mode is set to vocalization prohibition mode. In such cases, as described with reference to the flowchart shown in FIG. 8, output of control codes will not be performed and operating buttons will not be illuminated even if the illumination mode is set to illumination control mode in which operating buttons are illuminated. However, during the vocalization prohibition mode, by preparing guidance data, such as the guidance data 300 shown in FIG. 12, to which a second control code is added, illumination of an operating button may be executed independently from the vocalization of an audible text in the event that the illumination mode is set to illumination control mode even when illumination of the operating button is not executed with respect to vocalization of the audible text.

In the example shown in FIG. 12, the enter key 103c, which is illuminated in synchronization with the vocalization of the sentence “Press enter key” when the vocalization mode is set to vocalization control mode, is illuminated even when the vocalization mode is set to vocalization prohibition mode.

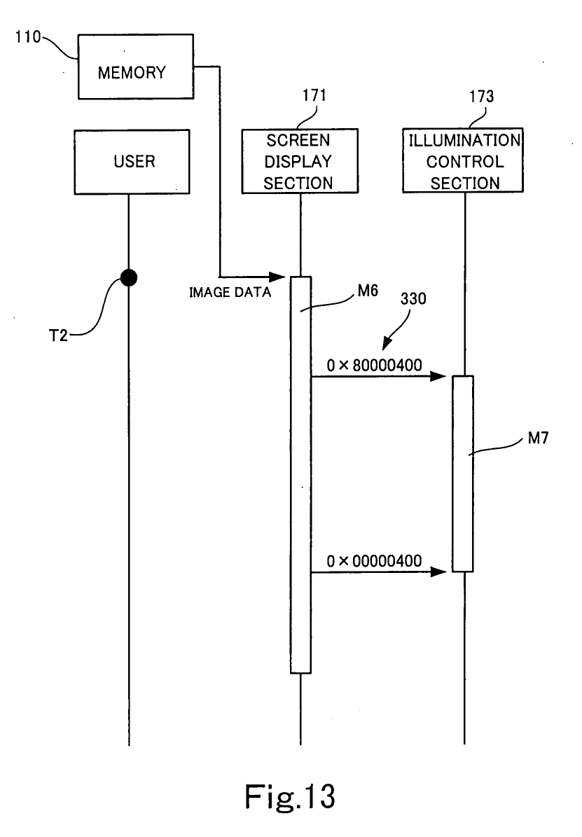

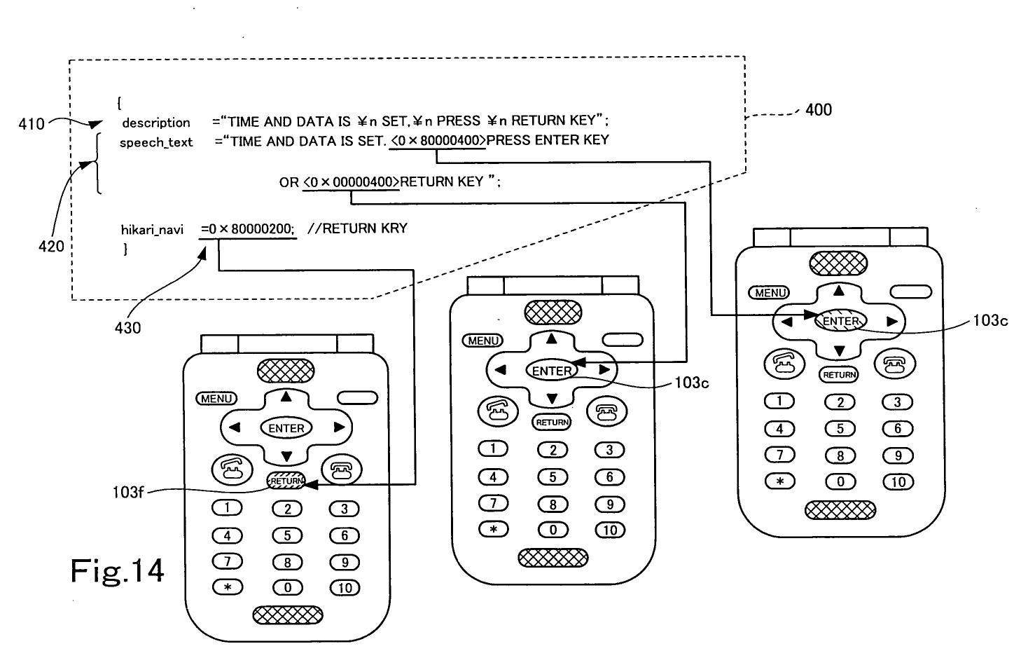

FIG. 13 is a schematic diagram showing operations of the mobile phone executed based on the guidance data shown in FIG. 12 in a case in which the vocalization mode is set to vocalization prohibition mode. In FIG. 13, operations of the first mobile phone 100 are represented by operations of the screen display section 171 and the illumination control section 173. Note that, since the vocalization mode is set to vocalization prohibition mode in the example shown in FIG. 13, the text vocalization section 172 is not operated and is therefore not illustrated.

The guidance data 300 shown in FIG. 12 is read out from the memory 110 at a time point T2 whereat the user operates the first mobile phone 100 with the intention of confirming time and date, and the screen display data 310 and the second control code 330 are handed over to the screen display section 171. The screen display section 171 executes display M6 of an operation screen based on the screen display data 310, and sends the second control code 330 to the illumination control section 173 upon lapse of a predetermined period of time after commencement of the display M6 of the operation screen. Upon receiving the second control code 330, the illumination control section 173 executes illumination M7 of the enter key 103c. In addition, after sending out the second control code 330, the screen display section 171 sets a timer to the illumination duration. The timer outputs a timer expiration event when the time elapsed from the commencement of illumination M7 reaches the illumination duration. Upon receiving the timer expiration event, the screen display section 171 sends the extinguishing control code “0x00000400” that extinguishes the enter key 103c to the illumination control section 173. Upon receiving the extinguishing control code, the illumination control section 173 concludes illumination M7 (extinguishes the enter key 103c).

As seen from the example explained above, for instance, by attaching a second control code corresponding to operations of an operating button that the user should be particularly aware of to guidance data containing the button operation, the operating button that the user should be particularly aware of may be illuminated independently from vocalization after conclusion of the vocalization even when illumination of the operating button is not executed with respect to vocalization in the event that the user has set the vocalization mode to vocalization prohibition mode.

In addition, while a case in which the vocalization mode is set to vocalization prohibition mode is described with reference to FIG. 13, the following effect may be gained by adding the second control code when the vocalization mode is set to vocalization control mode. In this case, the enter key 103c that is illuminated once during vocalization is once again illuminated after conclusion of vocalization. In this manner, by once again illuminating an operating button after conclusion of vocalization, the user may be reminded of an operating button to be operated.

Next, another example of guidance data to which the second control code is added will be described.

FIG. 14 is a diagram showing an example of guidance data, which differs from that shown in FIG. 12, to which a second control code is added.

Similar to the guidance data 300 shown in FIG. 12, guidance data 400 shown in FIG. 14 describes a button operation for confirming a set time and date, and is provided with screen display data 410 and an audible text 420 corresponding to this button operation. In addition, a second control code 430 that illuminates an operating button independently from the audible text 420 after conclusion of vocalization thereof has been added to the guidance data 400.

In the example shown in FIG. 14, during vocalization of the audible text 420, illumination and extinguishing of the enter key 103c are executed in synchronization with the vocalization of the phrase “Press enter key or”, and after conclusion of vocalization thereof, a return key 103f corresponding to the last phrase “return key” of the audible text 420 is illuminated.

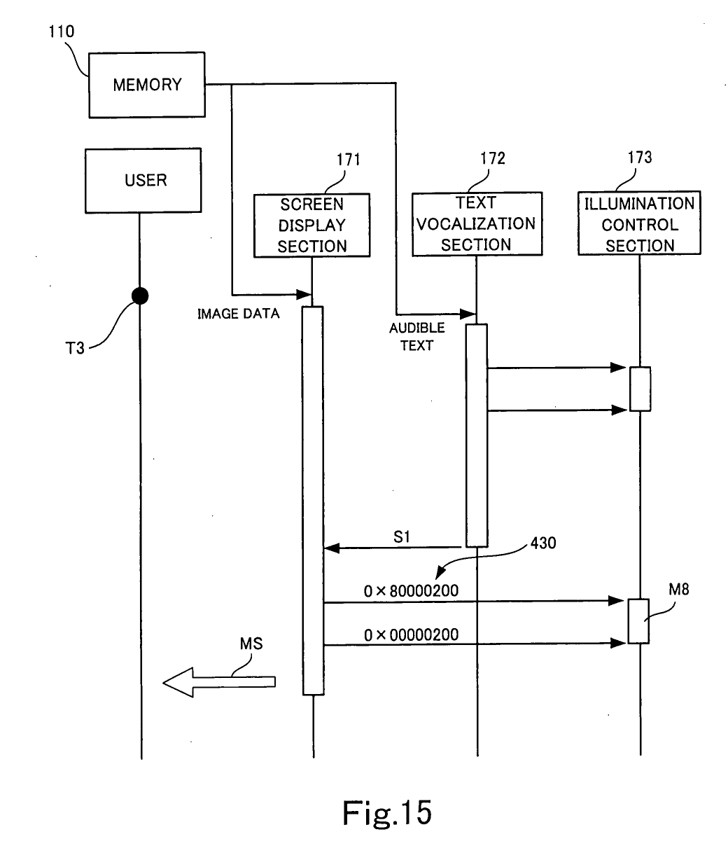

FIG. 15 is a schematic diagram showing operations of the mobile phone executed based on the guidance data shown in FIG. 14. In FIG. 15, operations of the first mobile phone 100 are also represented by operations of the screen display section 171, the text vocalization section 172 and the illumination control section 173.

The guidance data 400 is read out from the memory 110 at a time point T3 whereat the user operates the first mobile phone 100 with the intention of confirming the time and date, and screen display data 410 is handed over to the screen display section 171 while an audible text 420 is handed over to the text vocalization section 172. Repetitive descriptions on various controls executed based on the audible text 420 will be omitted.

Upon conclusion of vocalization of the audible text 420, the text vocalization section 172 sends the vocalization conclusion notification S1 to the screen display section 171. The screen display section 171 sends the second control code 430 that illuminates the return key 103f to the illumination control section 173 at a timing of reception of the vocalization conclusion notification S1. Upon receiving the second control code 430, the illumination control section 173 executes illumination M8 of the return key 103f. When a lapse of an illumination duration set by the illumination duration setting section 139 is confirmed by a timer expiration event outputted by the timer, the text vocalization section 172 sends an extinguishing control code “0x00000200” that extinguishes the return key 103f to the illumination control section 173. Upon receiving the extinguishing control code, the illumination control section 173 concludes the illumination M8 (extinguishes the return key 103f). Finally, the screen display section 171 executes notification processing MS of vocalization conclusion notification to the user via the display screen 102.

As seen from the example described above, for instance, in cases where there is an operating button that is always operated at the end of a series of button operations, the operating button may be illuminated after conclusion of vocalization by adding a second control code corresponding to the operating button to the guidance data.

As described with reference to FIGS. 2 to 15, in the present embodiment, when a sentence corresponding to a certain operating button is being vocalized during vocalization of an audible text explaining a button operation, the operating button will be illuminated in synchronization with the vocalization of that sentence. In other words, according to the first mobile phone 100, guidance that may be easily understood by users is provided on button operations.

A second embodiment of an electronic device according to the present invention will now be described. In the following description, emphasis will be placed on differences with the first embodiment.

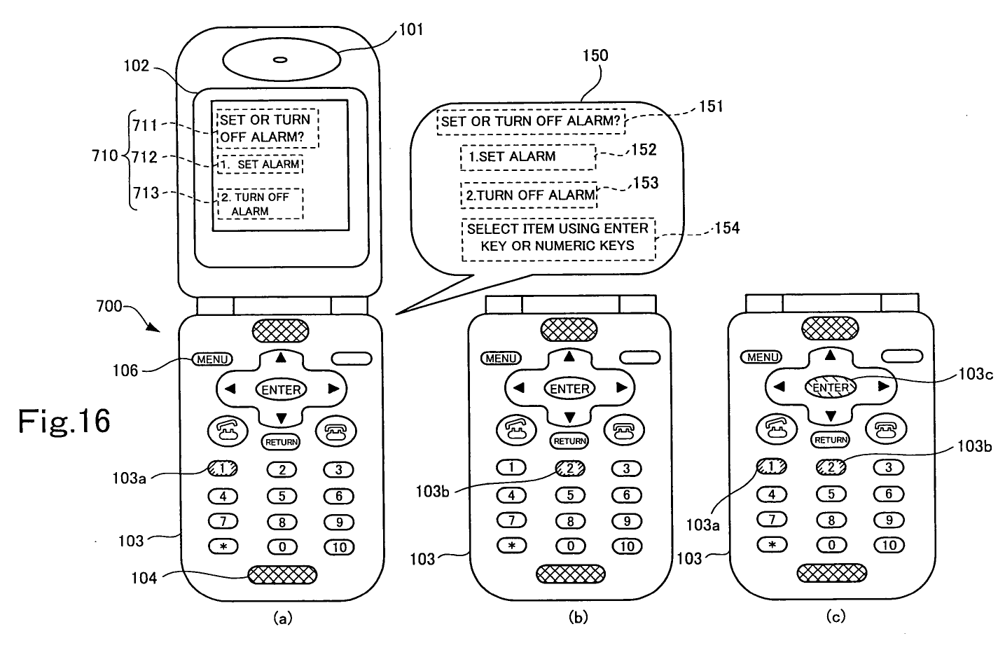

FIG. 16 is an external view of a second mobile phone that is a second embodiment of an electronic device according to the present invention.

With the exception of display modes of operation screens which differ from the first mobile phone 100 shown in FIG. 2, the second mobile phone 700 shown in FIG. 16 is the same as the first mobile phone 100. Therefore, in FIG. 16, elements other than an operation screen 710 that is the difference between the two mobile phone are assigned same reference characters as used in FIG. 2, and repetitive descriptions on these elements will be omitted.

FIG. 16 shows the operation screen 710, which corresponds to button operations related to settings of the alarm clock function and which consists of a first display portion 711 of “Set or turn off alarm?”, a second display portion 712 of “1. Set alarm”, and a third display portion 713 of “2. Turn off alarm” in a similar manner as FIG. 2, as an example of an operation screen displayed on the display screen 102. With the second mobile phone 700, during vocalization of a text 150, when a second sentence 152 is being vocalized, the “1” key 103a that corresponds to the second sentence 152 is illuminated as shown in part (a) of FIG. 16 and the color of the second display portion 712 corresponding to the “1” key 103a on the operation screen 710 is changed. Additionally, when the third sentence 153 is being vocalized, the “2” key 103b that corresponds to the third sentence 153 is illuminated as shown in part (b) of FIG. 16, the second display portion 712 is changed back to its original color, and the third display portion 713 corresponding to the “2” key 103b is changed. When a fourth sentence 154 is being vocalized, all three operating buttons (the “1” key 103a, the “2” key 103b and the enter key 103c) corresponding to the fourth sentence 154 are illuminated as shown in part (c) of FIG. 16, and the third display portion 713 is changed back to its original color.

As seen, with the second mobile phone 700, each operating button is illuminated in synchronization with a vocalization of a sentence corresponding to the operating button, and the color of a display portion corresponding to the illuminated operating button on the display screen is changed. As a result, a user may easily understand which operating button the guidance offered by the currently vocalized sentence corresponds to.

Since the hardware configuration of the second mobile phone 700 shown in FIG. 16 is the same as the hardware configuration of the first mobile phone 100 shown in FIG. 3, diagrammatic representations and repetitive descriptions of the hardware configuration of the second mobile phone 700 will be omitted. Instead, a description will now be given on a second control program that is a second embodiment of the control program according to the present invention, which controls the respective components of the second mobile phone 700.

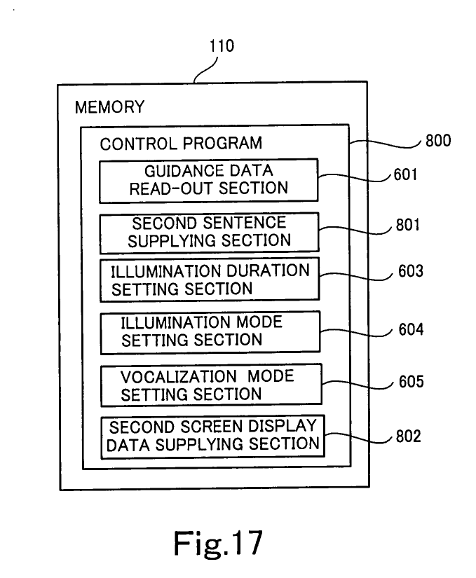

FIG. 17 is a schematic diagram showing the second control program that is a second embodiment of a control program according to the present invention, which is stored in a memory of the second mobile phone shown in FIG. 16. In this case, with the exception of a second sentence supplying section 801 and a second screen display data supplying section 802, the second control program 800 is the same as the first control program 600 shown in FIG. 4. Thus, in FIG. 17, like elements to those used in FIG. 4 are assigned like reference numerals as FIG. 4, and repetitive descriptions thereof will be omitted.

When the second sentence supplying section 801 that is a program component is executed by the CPU of the second mobile phone 700, upon transmission of a control code that illuminates an operating button by the second sentence supplying section 801 to a button illumination section of the second mobile phone 700, a display color control signal that changes the color of a display portion corresponding to the control code in the operation screen is sent to a display control section of the second mobile phone 700 at the timing whereat the control code is transmitted. In addition, when a control code that extinguishes an operating button is sent to the button illumination section of the second mobile phone 700, a display color control signal that changes back the color of the display portion to its original color is sent to the display control section of the second mobile phone 700 at the timing whereat the control code is transmitted.

Furthermore, when the second screen display data supplying section 802 that is a program component is executed by the CPU of the second mobile phone 700, upon reception of a display color control signal that changes or changes back the color of the display portion by the display control section of the second mobile phone 700, the display control section changes or changes back the color of the display portion corresponding to the display color control signal on the operation screen based on the display color control signal.

Next, vocalization of an audible text and illumination control of operating buttons executed by the second mobile phone 700 will be described.

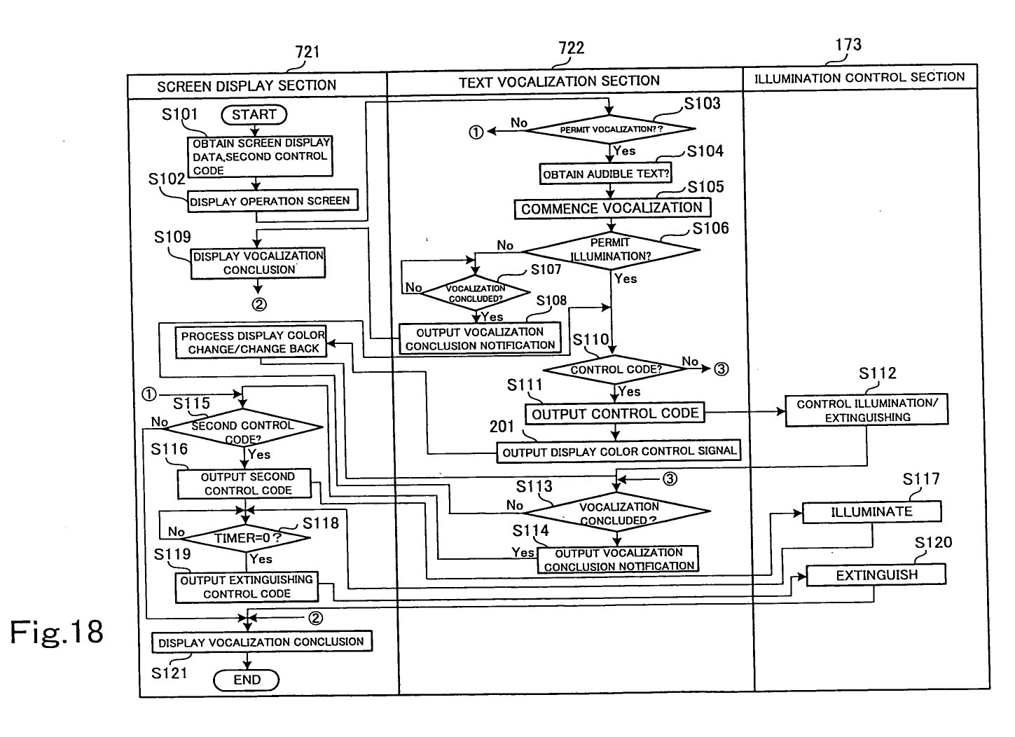

FIG. 18 is a flowchart showing processing flows of vocalization and illumination control of an operating button. In a similar manner to the flowchart shown in FIG. 8, the processing flow shown by the flowchart of FIG. 18 is represented as flows of processing respectively executed by the three components of the second mobile phone 700. In this case, FIG. 18 shows flows of processing respectively executed by the three elements, namely, a screen display portion 721 and the text vocalization section 722 that are configured to include execution of the control program 800 shown in FIG. 17, and an illumination control section 173 that is similar to the illumination control section 173 shown in FIG. 8 and is thus assigned the same reference numeral as the illumination control section 173. In addition, with the exception of processing related to changing or changing back the color of the display portion, the processing is similar to that represented by the flowchart shown in FIG. 8. Thus, in FIG. 18, like processes to those shown in FIG. 8 are assigned like reference numerals as FIG. 8, and repetitive descriptions thereof will be omitted.

When a control code is sent to the illumination control section 173 in the processing performed in step S111, the text vocalization section 722 sends the screen display section 721 a display color control signal that changes or changes back the color of a display portion corresponding to the control code of an operation screen displayed by the screen display section 721 in the processing performed in step S102 (step S201). Upon receiving the display color control signal, the screen display section 721 executes changing or changing back of the color of the display portion based on the display color control signal (step S202).

In the processing represented by the flowchart shown in FIG. 18, changing or changing back of the color of the display portion performed in the processing of steps S201 and S202 is continued until vocalization is concluded.

Next, taking the guidance data 200 shown in FIG. 9 as an example of guidance data, operations of the second mobile phone 700 executed based on the guidance data 200 will be described. In the same manner as FIG. 18, the operations of the second mobile phone 700 will be described through the respective operations of the screen display portion 721, the text vocalization section 722 and the illumination control section 173.

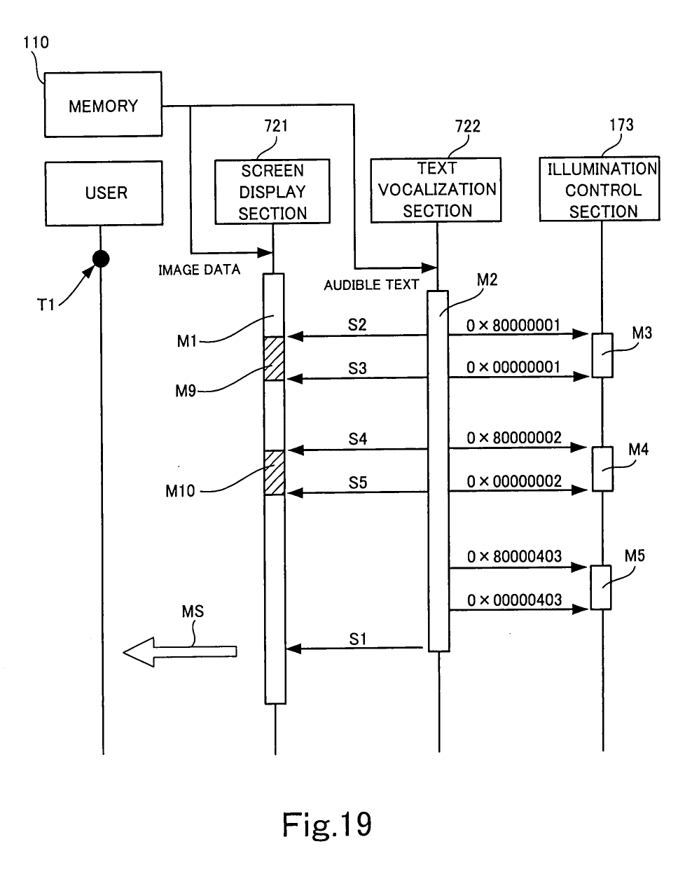

FIG. 19 is a schematic diagram showing operations of the mobile phone executed based on the guidance data shown in FIG. 9. Since illumination or extinguishing of operating buttons performed between the text vocalization section 722 and the illumination control section 173 are similar to illumination or extinguishing of operating buttons performed between the text vocalization section 172 and the illumination control section 173 shown in FIG. 11, and processing related to the vocalization conclusion notification S1 performed between the screen display portion 721 and the text vocalization section 722 is similar to the processing related to the vocalization conclusion notification S1 performed between the screen display portion 171 and the text vocalization section 172 shown in FIG. 11, repetitive descriptions thereof will be omitted.

As shown in FIG. 19, when sending the control code “0x80000001” that illuminates the “1” key 103a to the illumination control section 173, the text vocalization section 722 sends a display color control signal S2 that changes the color of the second display portion 712 shown in FIG. 16, which corresponds to the control code, to the screen display portion 721. Upon receiving the display color control signal S2, the screen display portion 721 executes a color change M9 of the second display portion 712. Then, in the event that the text vocalization section 722 sends the screen display portion 721 a display color control signal S3 that changes back the color of the second display portion 712 when sending the control code “0x00000001” that extinguishes the “1” key 103a to the illumination control section 173, upon receiving the display color control signal S3, the screen display portion 721 concludes the color change M9 of the second display portion 712 (changes back the color of the second display portion 712 to its original color). Similarly, in the event that the text vocalization section 722 sends the screen display portion 721 a display color control signal S4 that changes the color of the third display portion 713 when sending the control code “0x80000002” that illuminates the “2” key 103b to the illumination control section 173, the screen display portion 721 executes color change M10 of the third display portion 713. Furthermore, in the event that the text vocalization section 722 sends the screen display portion 721 a display color control signal S5 that changes back the color of the third display portion 713 to its original color when sending the control code “0x00000002” that extinguishes the “2” key 103b to the illumination control section 173, the screen display portion 721 concludes the color change M10 of the third display portion 713 (changes back the color of the third display portion 713 to its original color).

As seen, according to the second mobile phone 700 described with reference to FIGS. 16 to 19, the user may learn which display portion among a currently displayed operation screen an operating button currently being illuminated in synchronization with a vocalization of guidance of a button operation corresponds to, and therefore may further enhance understanding on the guidance on the button operation.

While the first mobile phone 100 has been taken as an example in describing an embodiment of an electronic device according to the present invention, an electronic device according to the present invention need not be limited to this example. Instead, any electronic device, such as a digital camera, having multiple operating buttons and which executes operations according to button operations may be used.

In addition, while the screen display section 171 which changes the color of a display portion corresponding to an illuminated operating button on an operation screen has been described as an example of a screen display section as defined by the present invention, a screen display section according to the present invention need not be limited to this example. Instead, any screen display section, such as a screen display section in which the display portion is displayed by blinking, may be used as long as a display mode of an object display portion is changed.

1. An electronic device equipped with multiple operating buttons and which executes operations according to button operations, the electronic device comprising:
a storage section that stores an audible text explaining a button operation;
a text vocalization section that reproduces a vocalization of the audible text read out from the storage section; and
an illumination control section that illuminates an operating button that corresponds to a sentence forming a portion of the audible text in synchronization with the vocalization of that sentence by the text vocalization section.

2. The electronic device according to claim 1, wherein:
the storage section stores audible texts into which control codes that control illumination and extinguishing of operating buttons are added;
the text vocalization section vocalizes an audible text read out from the storage section with the exception of the control codes, and hands over one of the control codes to the illumination control section at a timing whereat vocalization has proceeded up to that control code; and
the illumination control section controls illumination and extinguishing of operating buttons based on the control code received from the text vocalization section.

3. The electronic device according to claim 1, wherein:
the storage section stores, in addition to the audible text, screen display data associated with the audible text; and
the electronic device comprises a screen display section that displays a screen based on screen display data associated with the audible text when the audible text is vocalized by the text vocalization section.

4. The electronic device according to claim 3, wherein:
the storage section stores screen display data that is used to display a screen that includes a display portion associated with an operating button; and
the screen display section changes the display mode of the display portion, which is associated with the operating button, on a display screen in synchronization with illumination of the operating button by the illumination control section.

5. The electronic device according to claim 1, wherein:
the storage section further stores a second control code that controls illumination of an operating button that is independent from an audible text and is different from the control code that controls illumination and extinguishing of the operating button which is added to the audible text; and
the illumination control section controls illumination and extinguishing of an operating button using both the control code added to the audible text and the second control that is independent from the audible text.

6. The electronic device according to claim 5, wherein the illumination control section controls illumination and extinguishing of an operating button in accordance with a control code added to an audible text, and after control according to the control code is performed, the illumination control section controls illumination of the operating button based on a second control code that is independent from the audible text.

7. The electronic device according to claim 5, comprising an illumination duration setting section that sets, according to an operation, a duration between illumination and extinguishing of an operating button that is illuminated based on the second control code,
wherein when the operating button is illuminated based on the second control code, the illumination control section extinguishes the operating button after a lapse of the duration set by the illumination duration setting section.

8. The electronic device according to claim 1, comprising an illumination mode setting section that sets, according to operations, an illumination control mode that performs illumination control of an operating button using the illumination control section in synchronization with a vocalization of an audible text by the text vocalization section, and an illumination prohibition mode that prohibits illumination control,
wherein the illumination control section operates only when the illumination control mode is set by the illumination mode setting section.

9. The electronic device according to claim 1, comprising a vocalization mode setting section that sets, according to operations, a vocalization control mode that performs vocalization of an audible text using the text vocalization section and a vocalization prohibition mode that prohibits vocalization,
wherein the text vocalization section operates only when the vocalization control mode is set by the vocalization mode setting section.

10. A computer readable storage medium storing a control program that causes a computer to operate as an electronic device, which is equipped with multiple operating buttons and executes operations according to button operations, the electronic device comprising:
a storage section that stores an audible text explaining a button operation;
a text vocalization section that reproduces a vocalization of the audible text read out from the storage section; and
an illumination control section that illuminates an operating button that corresponds to a sentence forming a portion of the audible text in synchronization with the vocalization of that sentence by the text vocalization section.
